(19) United States
(12) Patent Application Publication
(10) Pub. No.: US 2008/0085431 A1
(43) Pub. Date: Apr. 10, 2008

(54) FUEL CELL SYSTEM

(76) Inventors: Ryuji Kohno, Kasumigaura (JP); Makoto Kitano, Tsuchiura (JP); Miyuki Fukushi, Hitachinaka (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/626,878

(22) Filed: Jan. 25, 2007

(30) Foreign Application Priority Data
Oct. 6, 2006 (JP) 2006-274594

(51) Int. Cl. H01M 8/04

(52) U.S. Cl. 429/12

(57) ABSTRACT

A fuel cell system is provided which can constantly control a fuel concentration of a liquid fuel supplied to a fuel cell, such as a DMFC. A DMFC system comprises a high-concentration cartridge in which a methanol aqueous solution having a concentration higher than a target fuel concentration is sealed, a water cartridge in which water is sealed, a mixing tank for mixing the methanol aqueous solution from the high-concentration cartridge with the water from the water cartridge to prepare the methanol aqueous solution having the target fuel concentration, and the DMFC for generating electricity by being supplied with the methanol aqueous solution from the mixing tank and air.

### CLAIM OF PRIORITY

The present application claims priority from Japanese Application Serial No. 2006-274594, filed on Oct. 6, 2006, the content of which is hereby incorporated by reference into this application.

### FIELD OF THE INVENTION

The present invention relates to a fuel cell system including a fuel cell for generating electricity by being supplied with a liquid fuel.

### BACKGROUND OF THE INVENTION

In recent years, fuel cells, such as a direct methanol fuel cell (DMFC), have been increasingly developed. The DMFC includes a membrane electrode assembly (MEA) having an anode (fuel electrode) and a cathode (air electrode) with an electrolyte membrane sandwiched therebetween. A methanol aqueous solution (liquid fuel) is supplied to the anode, and air containing oxygen (oxidant gas) to the cathode, respectively, so that the MEA, that is, DMFC generates electricity.

An electrode reaction as indicated by the equation (1) occurs at an anode 43 of a MEA 41 constituting a DMFC. An electrode reaction as indicated by the equation (2) occurs at a cathode 44 (see FIG. 1). Methanol (CH₃OH) serving as a fuel component and water (H₂O) are consumed at a molar ratio of 1:1 at the anode 43. For this reason, in theory, a methanol aqueous solution having a methanol concentration (fuel concentration) of 64 wt % (weight percent) may be supplied to the anode 43.

CH₃OH+H₂O→CO₂+6H⁺+6e⁻ (1)

O₂+4H⁺+4e⁻→2H₂O (2)

However, in fact, as shown in FIG. 1, some of methanol may pass from the anode 43 to the cathode 44 (which phenomenon is called “cross-over”), without relation to the electrode reaction, and water (hereinafter referred to as an “associated water”) may move together with protons (H⁺) transferring through an electrolyte membrane 42 toward the cathode 44. Therefore, at the anode 43, the methanol and water are not consumed according to the equation (1), which causes a difference in consumed amount of methanol and water between the theoretical value and the actual one. As a result, the methanol concentration cannot be maintained appropriately.

Accordingly, a technique has been proposed in which the methanol aqueous solution is mixed with water produced at the cathode 44 based on the equation (2) to have the concentration of methanol aqueous solution adjusted to an appropriate value, and then the thus-obtained solution is supplied to the anode 43 (as disclosed in a patent document 1).

[Patent Document 1] JP-A No. 319494/2004 (0014-0023, FIG. 1)

### SUMMARY OF THE INVENTION

In the technique as disclosed in the patent document 1, however, water is not produced at the cathode just at the start of electric power generation by the DMFC, ant thus at this time the methanol aqueous solution cannot be disadvantageously controlled to the appropriate concentration.

It is therefore an object of the invention to provide a fuel cell system that can constantly control a fuel concentration of a liquid fuel supplied to a fuel cell, such as a DMFC.

In order to solve the above-mentioned problems, the invention provides a fuel cell system which comprises a first cartridge in which a first liquid fuel having a first fuel concentration higher than a target fuel concentration is sealed, a water cartridge in which water is sealed, a mixer for mixing the first liquid fuel from the first cartridge with the water from the water cartridge to prepare a target concentration liquid fuel having the target fuel concentration, and a fuel cell for generating electricity by being supplied with the target concentration liquid fuel from the mixer and an oxidant gas.

According to the fuel cell system, the first fuel from the first cartridge is mixed with the water from the water cartridge in the mixer thereby to prepare the target concentration liquid fuel having the target fuel concentration. This target concentration liquid fuel is supplied to the fuel cell.

Therefore, not only during the electricity generation of the fuel cell, but also even at the start of the electricity generation in which produced water is not generated at the cathode, the target concentration liquid fuel can be prepared and supplied to the fuel cell.

According to the invention, a fuel cell system is provided which can constantly control a fuel concentration of a liquid fuel supplied to a fuel cell, such as the DMFC.

### BRIEF DESCRIPTION OF THE DRAWINGS

FIG. 1 is a schematic diagram showing a moving state of material in a MEA of a DMFC;

FIG. 2 is a graph showing a relationship between a methanol concentration in a methanol aqueous solution supplied to the DMFC and a mass balance at an anode;

FIG. 3 is a graph showing a change in amount of residual fuel and in fuel concentration with elapsed time in both cases of dividing of supply of the methanol aqueous solution and not dividing of supply thereof;

FIG. 4 is a diagram showing a construction of a DMFC system according to a first embodiment of the invention;

FIG. 5 is a diagram showing a construction of a DMFC system according to a second embodiment;

FIG. 6 is a diagram showing a construction of a DMFC system according to a third embodiment; and

FIG. 7 is a diagram showing a construction of a DMFC system according to a fourth embodiment and shows an attached state of a target concentration cartridge; and

FIG. 8 is a diagram showing a construction of the DMFC system according to the fourth embodiment and shows a detached state of the target concentration cartridge.

### DESCRIPTION OF THE PREFERRED EMBODIMENTS

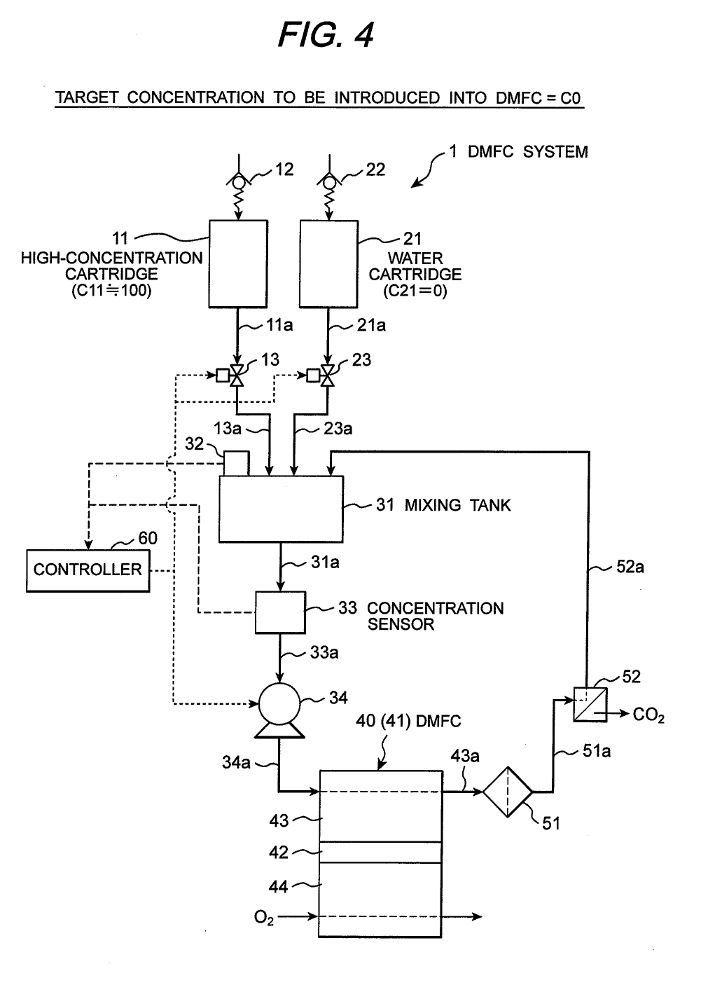

Reference will now be made hereinafter to the concept of the invention. When a DMFC 40 (see FIG. 4) generates electricity, an electrode reaction as indicated by the equation (1) occurs at an anode 43 of a MEA 41 constituting the DMFC, and an electrode reaction as indicated by the equation (2) occurs at a cathode 44 thereof, respectively. In theory, the methanol and water are consumed at a molar ratio of 1:1 at the anode 43.

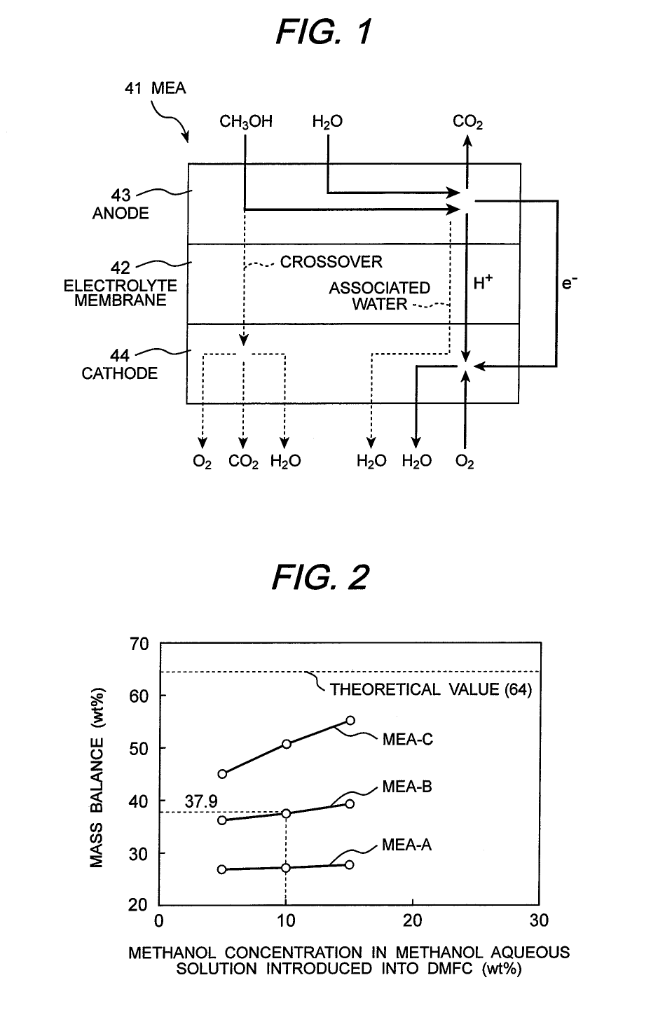

Furthermore, the cross-over of the methanol and the moving of the associated water occur as shown in FIG. 1.

CH₃OH+H₂O→CO₂+6H⁺+6e⁻ (1)

O₂+4H⁺+4e⁻→2H₂O (2)

A ratio of a consumed amount (g) of the methanol to a consumed amount (g) of the entire methanol aqueous solution at the anode 43 (which is hereinafter referred to as a “mass balance” (wt %)) is represented by the following equation (3). Taking into consideration the cross-over of the methanol and the associated water, the equation (3) is developed to the equation (4).

$$\begin{matrix}[ Mathematical Formula 1 ] & \\ \begin{matrix}Mass Balance ( wt \% ) = \frac{Consumed Amount of Methanol ( g )}{\begin{matrix}Consumed Amount of Methanol \\ Aqueous Solution ( g )\end{matrix}} \times 100 \\ = \frac{\begin{matrix}Consumed Amount of Methanol \\ at Electrode Reaction + Crossover Amount\end{matrix}}{\begin{matrix}Consumed Amount of Methanol Aqueous \\ Solution at Electrode Reaction + \\ Crossover Amount + \\ Associated Water Amount\end{matrix}}\end{matrix} & \begin{matrix}( 3 ) \\ \\ \\ \\ ( 4 ) \\ \end{matrix}\end{matrix}$$

Thus, the equation (4) shows a trend that the larger the cross-over amount, the larger the mass balance becomes, whereas the larger the associated water amount, the smaller the mass balance becomes.

In detail, as shown in FIG. 2, the mass balance depends on properties of the MEA (transport number, moisture content, thickness, and ion exchange capacity of an electrolyte membrane 42) and the methanol concentration in the methanol aqueous solution introduced into the DMFC 40. That is, for example, when the methanol concentration becomes high, the cross-over amount becomes large (which is an increase in leakage of methanol), resulting in an increased mass balance according to the equation (4).

FIG. 2 shows that when the methanol aqueous solution having the methanol concentration of 10 (wt %) is introduced into the “MEA-B”, the mass balance becomes 37.9 (wt %).

Thus, in order to reduce the loss of the methanol, a mass balance that decreases the cross-over amount is set, and a concentration of the methanol aqueous solution introduced into the DMFC 40 is set (as a target concentration C0) based on the properties of the MEA used. This can reduce the loss of the methanol due to the cross-over, while allowing the DMFC 40 to generate electricity well.

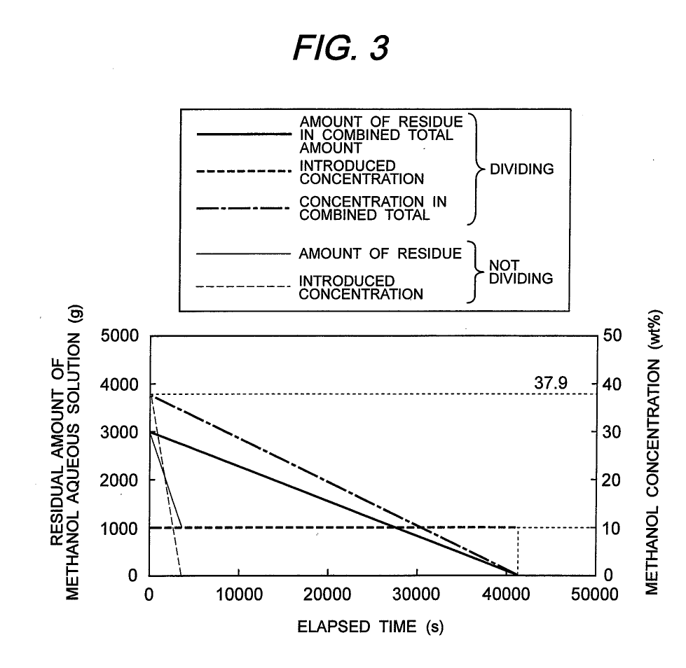

The inventors have obtained the following test result as shown in FIG. 3. More specifically, a methanol aqueous solution is introduced from one cartridge (corresponding to “not dividing”) in which the methanol aqueous solution (3000 g) having a methanol concentration of 37.9 (wt %) is sealed, into the MEA-B (see FIG. 2), in which the mass balance will become 37.9 (wt %) in introduction of a methanol aqueous solution having a methanol concentration of 10 (wt %). In this case, the methanol aqueous solution having the methanol concentration of 37.9 (wt %) is introduced as it is. Thus, the cross-over amount increases, and after about 3000 seconds, the methanol concentration is decreased to 0 (wt %), regardless of the presence of the residual methanol aqueous solution of about 1000 g. This may make it impossible for the DMFC 40 to generate electricity.

In contrast, in use of two cartridges (corresponding to dividing), whose contents are combined in total, the following test result has been obtained. More specifically, a methanol aqueous solution of 3000 g in total amount and having a methanol concentration of 37.9 (wt %) is divided into and sealed in the two cartridges. At this time, a methanol concentration in one cartridge is set to the target concentration C0 or less, and a methanol concentration in the other cartridge is set higher than the target concentration Co (for example, the methanol concentration in one cartridge is set to 0 (wt %), while the methanol concentration in the other cartridge is set to 100 (wt %)).

Then, the methanol aqueous solution(s) (and water) are supplied from these two cartridges to an appropriate mixer. In this mixer, a methanol aqueous solution of 10 (wt %) in concentration, which is equal to the target concentration C0, is prepared. In the case of introduction of the methanol aqueous solution having the concentration of 10 (wt %) into the DMFC 40, the amount of residue in combined total amount becomes zero at the time when the methanol concentration in combination of the two cartridges becomes zero, so that the electricity generation time of the DMFC 40 is extended up to about 41000 seconds.

As mentioned above, the inventors have found the following fact. Specifically, the target concentration C0 (the methanol concentration in the methanol aqueous solution introduced into the DMFC 40) is determined based on the mass balance (wt %) determined on the basis of the loss amount of the methanol or the like, and on the properties of MEA. The methanol aqueous solution corresponding to the mass balance (wt %) in combined total is divided into two cartridges.

The methanol concentration in one cartridge is set to the target concentration C0 or less, while the methanol concentration in the other cartridge is set higher than the target concentration C0. Using the methanol aqueous solution(s) (and water) from these two cartridges is prepared the methanol aqueous solution having the target concentration C0. When the solution prepared is introduced into the DMFC 40, the methanol loss due to the cross-over can be reduced, while enabling the DMFC 40 to effectively generate the electricity.

In the following embodiment, a DMFC system that can carry out such findings will be described.

### First Embodiment

Now, a DMFC system 1 (fuel cell system) according to a first embodiment of the invention will be described with reference to FIG. 4.

### <Construction of DMFC System>

As shown in FIG. 4, the DMFC system 1 mainly includes a high-concentration cartridge (first cartridge) 11, a water cartridge 21, a mixing tank (mixer) 31, and a DMFC (fuel cell) 40.

In the first embodiment, and in second to fourth embodiments to be described later, a methanol aqueous solution having the target concentration C0 (target fuel concentration) of methanol is introduced into the anode 43 of the DMFC 40.

In the high-concentration cartridge 11, a methanol aqueous solution (first liquid fuel) having a concentration C11 (wt %) (C0<C11≈100, first fuel concentration) is sealed. Such a high-concentration cartridge 11 is adapted to be detachably attached on a dock (not shown) of the DMFC system 1.

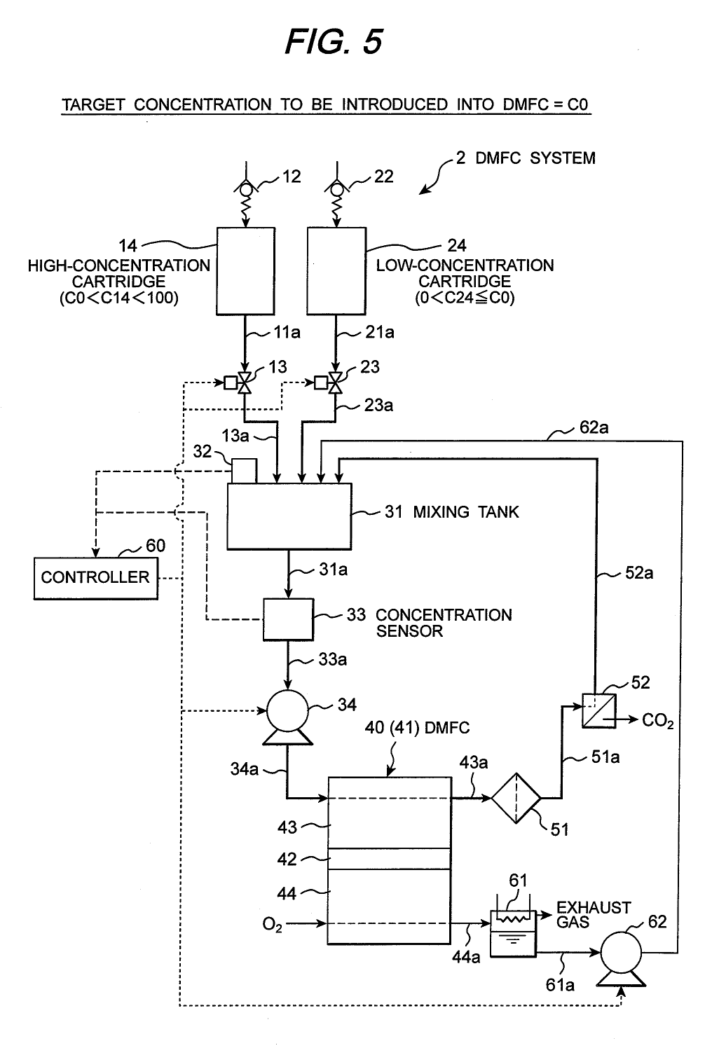

The high-concentration cartridge 11 and the water cartridge 21 differ in, for example, shape, and have respective pipes 11a, 21a, and adaptors (mistaken attachment prevention means) which also differ from each other in shape. Such an arrangement prevents the mistaken installation or attachment of the cartridges. Note that the mistaken installation of a high-concentration cartridge 14 to be described later and a low-concentration cartridge 24 or target concentration cartridge 25 is also prevented in the same manner (see FIGS. 5 to 8).

While a pump 34 to be described later is operated with the high-concentration cartridge 11 attached, when an opening/closing valve 13 is opened by a controller 60, a check valve 12 is opened by a suction force of the pump 34. The methanol aqueous solution having the concentration C11 is supplied from the high-concentration cartridge 11 to the mixing tank 31 via the pipe 11a, the opening/closing valve 13, and a pipe 13a. Adjusting the time of opening the valve 13 and the opening degree of the valve 13 controls the amount of the methanol aqueous solution having the concentration C11 supplied into the mixing tank 31.

The check valve 12 prevents the leakage of the methanol aqueous solution from the high-concentration cartridge 11 to the outside, while allowing the methanol aqueous solution to flow out promptly by the suction force of the pump 34. Instead of the check valve 12, for example, a semipermeable membrane through which the methanol aqueous solution cannot pass but through which air can pass may be provided. The same goes for a check valve 22 to be described later.

The opening/closing valve 13 and an opening/closing valve 23 are normally closed, and for example, intermittently opened by the controller 60 according to the amount of the methanol aqueous solution in the mixing tank 31 and the methanol concentration detected by a concentration sensor 33. Furthermore, accessories including the opening/closing valves 13, 23, the pump 34, the controller 60, and the like are operated using the DMFC 40 and/or a capacitor (not shown) as a power source.

In the water cartridge 21, pure water (preferably, deionized water) is sealed. In other words, a methanol concentration C21 in the water cartridge is zero (wt %). Such a water cartridge 21 is detachably installed or attached on the dock (not shown) of the DMFC system 1, like the high-concentration cartridge 11.

In operation of the pump 34 with the water cartridge 21 attached, when the opening/closing valve 23 is opened, the check valve 22 is opened by the suction force of the pump 34. Water is supplied from the water cartridge 21 to the mixing tank 31 via the pipe 21a, the opening/closing valve 23, and a pipe 23a. Adjusting the time of opening the valve 23 and the opening degree of the valve 23 controls the amount of water supplied to the mixing tank 31.

The mixing tank 31 is a tank for mixing the methanol aqueous solution having the concentration C11 from the high-concentration cartridge 11 with water from the water cartridge 21. Thus, the opening/closing valves 13 and 23 are appropriately opened to allow the methanol aqueous solution having the concentration C11 and the water to be supplied to the mixing tank 31 with the ratio of the methanol solution amount to the water amount set to a predetermined value. In the tank 31, the methanol aqueous solution having the target concentration C0 (liquid fuel of the target concentration) is prepared.

The mixing tank 31 is provided with a liquid amount sensor 32 for detecting the amount of the methanol aqueous solution therein. The liquid amount sensor 32 is connected to the controller 60, and the controller 60 is adapted to sense the amount of the methanol aqueous solution in the mixing tank 31.

When the pump 34 is operated according to a command from the controller 60, the methanol aqueous solution having the target concentration C0 in the mixing tank 31 is adapted to be supplied to the anode 43 of the DMFC 40 (MEA 41) via a pipe 31a, the concentration sensor 33, a pipe 33a, the pump 34, and a pipe 34a.

The concentration sensor 33 is a sensor for detecting the methanol concentration in the methanol aqueous solution to be introduced into the DMFC 40. For example, EMS-100 manufactured by Kyoto Electronics Manufacturing Co., Ltd. can be used as the sensor. The concentration sensor 33 is connected to the controller 60, and the controller 60 is adapted to sense the methanol concentration in the methanol aqueous solution to be introduced into the DMFC 40.

The DMFC 40 is a fuel cell that generates electricity by being supplied with the methanol aqueous solution (specifically, the methanol aqueous solution having the target concentration C0 from the mixing tank 31) and air containing oxygen. Such a DMFC 40 is, for example, a stack type of a plurality of MEAs 41 (see FIG. 1) which are laminated via separators (not shown) having flow paths formed thereon and through which the methanol aqueous solution or the air containing oxygen flows.

The air is supplied to the cathode 44 of the MEA 41, for example, by fans (not shown).

The outlet of the anode 43 side of the DMFC 40 is connected to the mixing tank 31 via a pipe 43a, a filter 51, a pipe 51a, a degasifier 52, and a pipe 52a. A discharged methanol aqueous solution (discharged liquid fuel) discharged from the anode 43 of the DMFC 40 is returned to the mixing tank 31 via these elements, mixed at the mixing tank 31, and then supplied again to the DMFC 40, whereby the methanol aqueous solution circulates therethrough. In other words, the pipes 43a, 51a, 52a, and the like constitute a discharge liquid fuel line for allowing the discharged methanol aqueous solution to return to the mixing tank 31.

The filter 51 is to remove dust or the like in the methanol aqueous solution.

The degasifier 52 is a device for removing carbon dioxide generated at the electrode reaction at the anode 43 from the methanol aqueous solution. Such a degasifier 52 incorporates therein a carbon dioxide separation membrane for allowing the carbon dioxide to selectively pass through.

The controller 60 is a device for electronically controlling the DMFC system 1, and includes a CPU, a ROM, a RAM, various interfaces, electronic circuits and the like.

### <Operation and Effect of DMFC System>

According to this DMFC system 1, the following main operation and effect can be obtained.

The controller 60 can prepare the methanol aqueous solution having the target concentration C0 at the mixing tank 31 by appropriately opening the opening/closing valve 13 and the opening/closing valve 23, while operating the pump 34. The methanol aqueous solution having the target concentration C0 can be supplied to the anode 43 of the DMFC 40. That is, in actuation of the system, even at the start of the electricity generation (just in the time of actuation of the system), the methanol aqueous solution having the target concentration C0 can be introduced into the anode 43.

When the power generation of the DMFC 40 proceeds and the liquid amount sensor 32 detects the decrease in amount of the methanol aqueous solution in the mixing tank 31, the controller 60 appropriately opens the opening/closing valve 13 and the opening/closing valve 23 to prepare the methanol aqueous solution having the target concentration C0 again in the mixing tank 31. This solution prepared can be introduced into the DMFC 40.

When the concentration sensor 33 detects that the concentration of the methanol aqueous solution introduced into the DMFC 40 is decreased to less than the target concentration C0 due to the discharged methanol aqueous solution, the controller 60 causes the opening/closing valve 13 to open, thereby increasing the methanol concentration up to the target concentration C0. In this case, the opening time of the opening/closing valve 13 is controlled based on, for example, the present methanol concentration and the amount of methanol aqueous solution in the mixing tank 31.

The methanol concentration in the methanol aqueous solution prepared after being introduced into the mixing tank 31 can be calculated by monitoring the opening time of the opening/closing valves 13, 23 (duty ratio of an opening valve signal to a closing valve signal, which are fed to the opening/closing valves 13, 23) by the controller 60, and by monitoring the flow rates of the methanol aqueous solution and water into the mixing tank 31 by a flow rate sensor (not shown). Such calculation of the methanol concentration can be carried out both instantly and cumulatively.

In this way, the methanol aqueous solution having the extremely high concentration of methanol is prevented from being introduced into the anode 43, even at the start of the electricity generation. Therefore, the amount of cross-over of the methanol which does not contribute to the electricity generation of the DMFC 40 is reduced, so that the methanol is consumed effectively, resulting in increased duration of the electricity generation of the DMFC 40. An exothermic reaction at the cathode 44 and degradation in the electrolyte membrane 42 or the like due to the cross-over of the methanol can be reduced, thereby enhancing the durability of the DMFC 40.

The high-concentration cartridge 11 and the water cartridge 21 are configured to have the respective full capacities that can prepare the methanol solution having the target concentration C0 when mixing the methanol aqueous solution filling in the high-concentration cartridge 11 with the water filling in the water cartridge 21. If the influence by the discharged methanol aqueous solution from the anode 43 is eliminated, the amounts of residues in both cartridges become zero at the same time. This permits the user of the DMFC system 1 to simultaneously replace the high-concentration cartridge 11 and the water cartridge 21, thereby reducing the complicity associated with the cartridge replacement. Note that this construction can be applied to the relationship between a high-concentration cartridge 14 and a low-concentration cartridge 24 to be described later in the same manner.

### Second Embodiment

Next, a DMFC system 2 according to a second embodiment will be described with reference to FIG. 2. The different points of this embodiment from the first embodiment will be mainly explained.

### <Construction of DMFC System>

As shown in FIG. 5, the DMFC system 2 includes a high-concentration cartridge 11 (C0<C14<100, first fuel concentration), instead of the high-concentration cartridge 11 (C11≈100), and a low-concentration cartridge 24 (0<C24≦C0, second fuel concentration), instead of the water cartridge 21 (C21=0). Both of the high-concentration cartridge 14 and the low-concentration cartridge 24 are adapted to be detachably installed on the dock (not shown) of the DMFC system 2.

In the high-concentration cartridge 14 (first cartridge), a methanol aqueous solution (first liquid fuel) having a concentration C14 (wt %) is sealed. In the low-concentration cartridge 24 (second cartridge), a methanol aqueous solution (second liquid fuel) having a concentration C24 (wt %) is sealed.

The outlet of the cathode 44 of the DMFC 40 is connected to the mixing tank 31 via a pipe 44a, a condenser 61, a pipe 61a, a pump 62, and a pipe 62a. The condenser 61 is a device for condensing (liquidizing) water vapor (produced water) produced by the electrode reaction at the cathode 44 and accompanied with off gas discharged from the cathode 44, by cooling the off gas (oxidant gas). When the pump 62 is operated according to a command from the controller 60, the produced water condensed by and stored in the condenser 61 is adapted to be supplied to the mixing tank 31 via the pipe 62a. In other words, the pipes 44a, 61a, 62a, and the like constitute a produced water supply line for supplying the produced water to the mixing tank 31.

As will be described later, the methanol aqueous solution may not be introduced from the low-concentration cartridge 24 after setting the concentration C24 of the methanol aqueous solution in the low-concentration cartridge 24 to the target concentration C0 and introducing the methanol aqueous solution from the low-concentration cartridge 24 into the mixing tank 31. Even this construction facilitates maintaining the total amount of the methanol aqueous solution circulating.

Such a produced water supply line of this embodiment may be combined appropriately with any one of the first embodiment, and third and fourth embodiments to be described later, as a matter of course.

### <Operation and Effect of DMFC System>

According to this DMFC system 2, the following main operation and effect can be obtained.

The concentration C14 of the methanol aqueous solution in the high-concentration cartridge 14 is in a rage of C0<C14<100 (wt %), which is lower than the concentration C11 (C11≈100) of the methanol aqueous solution in the high-concentration cartridge 11 of the first embodiment. Thus, for example, a seal incorporated in the opening/closing valve 13 is hardly degraded by the methanol, resulting in enhanced durability and safety of the system.

The concentration C14 of the methanol aqueous solution in the high-concentration cartridge 14 is in a range of C0<C14<100 (wt %), and the concentration C24 of the methanol aqueous solution in the low-concentration cartridge 24 is in a range of 0<C24≦C0 (wt %). The difference in concentration between the high-concentration cartridge 14 and the low-concentration cartridge 24 can be smaller than that between the high-concentration cartridge 11 and the water cartridge 21 of the first embodiment.

Furthermore, when setting the concentration C24 of the methanol aqueous solution in the low-concentration cartridge 24 to the target concentration C0, at the initial time of introduction of the methanol aqueous solution into the DMFC 40, the methanol aqueous solution having the concentration C24 (=C0) can be introduced from the low-concentration cartridge 24 into the DMFC 40 as it is. That is, at the initial introducing time, the methanol aqueous solution having the concentration C14 does not need to be supplied to the mixing tank 31 from the high-concentration cartridge 14, and thus the opening/closing valve 13 does not need to be opened.

Moreover, when setting the concentration C24 to the target concentration C0, the amount of the methanol aqueous solution sealed in the low-concentration cartridge 24 (the capacity of the low-concentration cartridge 24) may be preferably set to a value that allows the mixing tank 31 or the like to be appropriately filled up with the methanol aqueous solution circulating, and allows the methanol aqueous solution to circulate in the system.

In such a setting, after the initial introduction, the methanol continues to be consumed by the DMFC 40 generating electricity. When the amount of the methanol aqueous solution circulating and the methanol concentration are decreased, the methanol aqueous solution having the concentration C14 is supplied from the high-concentration cartridge 14 to the mixing tank 31, so that the amount of the methanol aqueous solution circulating and the methanol concentration can be restored.

Thus, after the initial introduction, the opening/closing valve 23 does not need to be opened, and only the opening/closing valve 13 is opened depending on the circulating methanol aqueous solution amount and the methanol concentration, thereby reducing the power consumption at the opening/closing valve 13 and the opening/closing valve 23, thus enhancing the electricity generation efficiency of the DMFC system 2.

### Third Embodiment

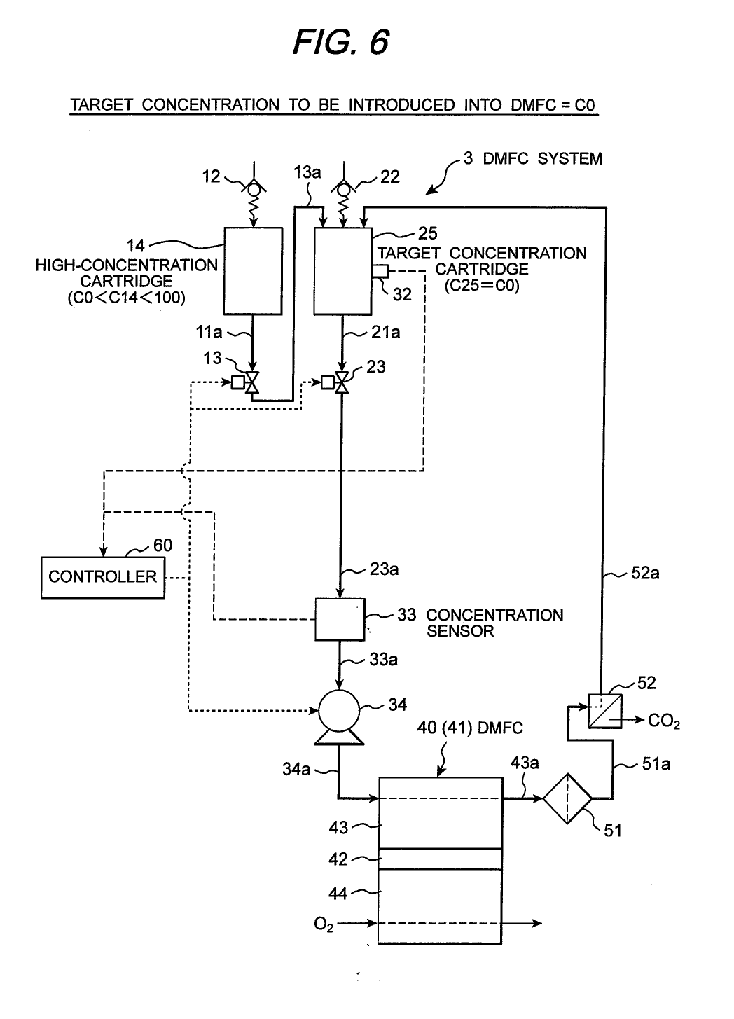

Next, a DMFC system 3 according to a third embodiment will be described with reference to FIG. 6. The different points of this embodiment from the second embodiment will be mainly explained.

### <Construction of DMFC System>

The DMFC system 3 includes a target concentration cartridge 25 (mixer), instead of the low-concentration cartridge 24 (0<C24≦C0). The target concentration cartridge 25 is detachably installed on the dock (not shown) of the DMFC system 3, and seals therein the methanol aqueous solution having the concentration C25 (wt %) (target concentration liquid fuel) equal to the target concentration C0.

The DMFC system 3 does not include the mixing tank 31 (see FIG. 5) and the downstream end of the opening/closing valve 23 is connected to the concentration sensor 33.

Like the case where the concentration C24 of the methanol aqueous solution in the low-concentration cartridge 24 is set to the target concentration C0 in the second embodiment, the methanol aqueous solution having the target concentration C0 (=C25) is supplied from the target concentration cartridge 25 to the DMFC 40 as it is at the start of the electricity generation at the DMFC 40.

The downstream end of the pipe 13a and the downstream end of the pipe 52a are connected to the target concentration cartridge 25. Thus, the methanol aqueous solution (third liquid fuel) having the concentration C14 (C0<C14<100, third fuel concentration) in the high-concentration cartridge 14 and the discharged methanol aqueous solution discharged from the DMFC 40 are supplied to the target concentration cartridge 25, where these solutions are mixed with each other.

### <Operation and Effect of DMFC System>

According to this DMFC system 3, the following main operation and effect can be obtained.

Since the mixing tank 31 is not provided, the construction of the DMFC system 3 becomes simple and compact.

When the electricity generation of the DMFC 40 proceeds and the methanol concentration in the methanol aqueous solution introduced into the DMFC 40 is decreased, the methanol aqueous solution having the concentration C14 (C0<C14<100) is added from the high-concentration cartridge 14 to the target concentration cartridge 25, thereby increasing the methanol concentration.

### Fourth Embodiment

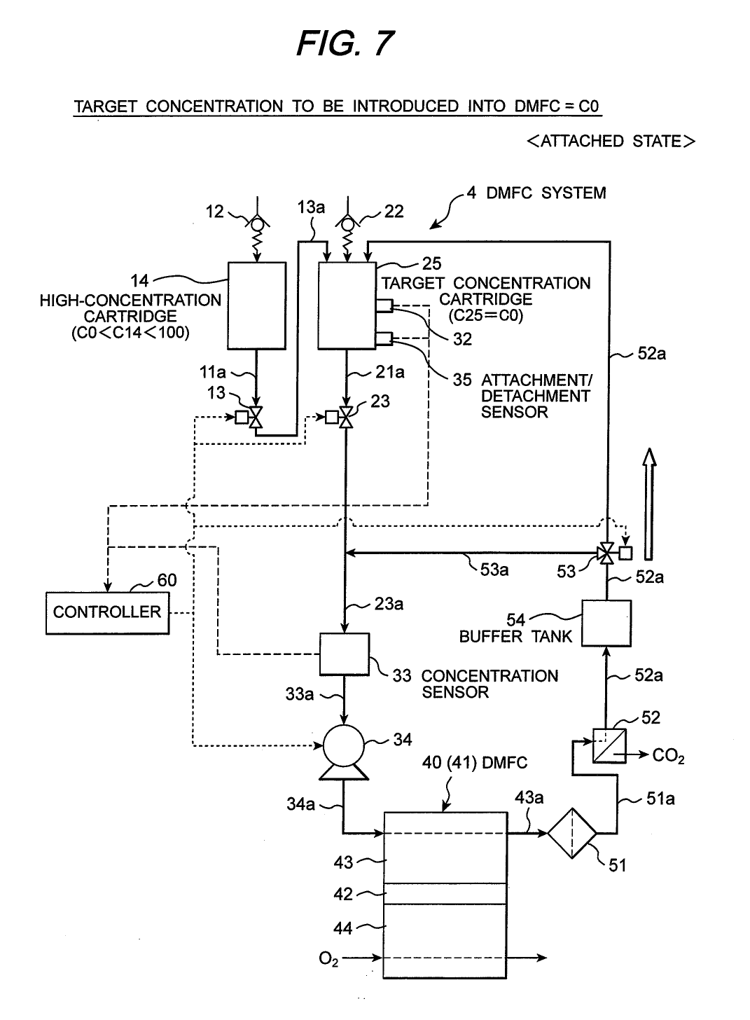

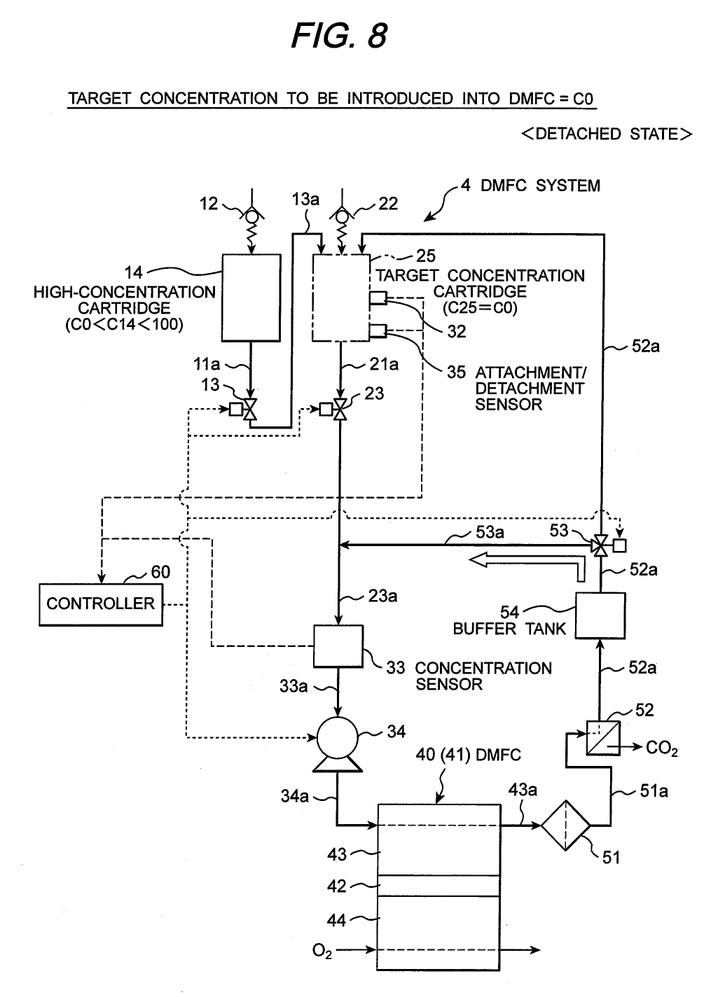

Next, a DMFC system 4 according to a fourth embodiment will be described with reference to FIGS. 7 and 8. The different points of this embodiment from the third embodiment will be mainly explained.

### <Construction of DMFC System>

The DMFC system 4 further includes an attachment/detachment sensor 35, a three-way valve 53, and a buffer tank 54.

The attachment/detachment sensor 35 is a sensor for detecting an attached/detached (desorption) state of the target concentration cartridge 25 which is detachable installed on the dock (not shown) of the DMFC system 4. The attachment/detachment sensor 35 is provided in an appropriate position. The attachment/detachment sensor 35 is connected to the controller 60, and the controller 60 is adapted to sense the detached state of the target concentration cartridge 25.

The three-way valve 53 is provided in the pipe 52a constituting the discharge liquid fuel line. The three-way valve 53 is connected to the pipe 23a via a pipe 53a. Furthermore, the three-way valve 53 is connected to the controller 60, by which the direction of flow of the methanol aqueous solution discharged from the anode 43 is controlled.

In detail, when detecting the attachment of the target concentration cartridge 25 via the attachment/detachment sensor 35, the controller 60 is adapted to control the three-way valve 53 such that the discharged methanol aqueous solution flows toward the target concentration cartridge 25 (see FIG. 7). In contrast, when detecting the detachment (desorption) of the target concentration cartridge 25 via the attachment/detachment sensor 35, the controller 60 is adapted to control the three-way valve 53 such that the discharged methanol aqueous solution bypasses the target concentration cartridge 25 to be directed toward the pipe 23a (see FIG. 8).

That is, in the fourth embodiment, a bypass line for allowing the discharged methanol aqueous solution to bypass the target concentration cartridge 25 (mixer) and to return to the upstream side of the DMFC 40 is constituted of the pipe 53a. Allowance means for allowing the discharged methanol aqueous solution to flow to the pipe 53a (bypass line) includes the attachment/detachment sensor 35, the three-way valve 53, and the controller 60.

The allowance means is not limited to the construction described above. For example, the pipe 52a and the pipe 53a may be respectively provided with opening/closing valves, which may be appropriately opened and closed. The construction that interlocks the three-way valve 53 with the attached/detached state of the target concentration cartridge 25 among the allowance means may be a mechanical one in which the three-way valve 53 is operated via an interlocking arm not shown, for example, when detaching the target concentration cartridge 25 (in the detached state).

The buffer tank 54 is provided in the pipe 52a (on a line in the bypass) between the degasifier 52 and the three-way valve 53. The buffer tank 54 stores therein the discharged methanol aqueous solution. The buffer tank 54 has a capacity set to a value that allows the discharged methanol aqueous solution to appropriately circulate when the target concentration cartridge 25 is removed for replacement or the like of the cartridge 25 and the methanol solution bypasses the target concentration cartridge 25.

### <Operation and Effect of DMFC System>

According to this DMFC system 4, the following main operation and effect can be obtained.

For replacement of the target concentration cartridge 25, the discharged methanol aqueous solution in the buffer tank 54 is supplied to or circulates through the anode 43 via the pipe 53a (bypass line) with the target concentration cartridge 25 being removed, thereby continuing the electricity generation of the DMFC 40.

Although each preferable embodiment of the invention has been described above, the invention is not limited thereto. The respective constructions of the embodiments may be combined appropriately, and various modifications may be made to the embodiments set forth herein without departing from the scope of the invention.

What is claimed is:

1. A fuel cell system comprising:
a first cartridge in which a first liquid fuel having a first fuel concentration higher than a target fuel concentration is sealed;
a water cartridge in which water is sealed;
a mixer for mixing the first liquid fuel from the first cartridge with the water from the water cartridge to prepare a target concentration liquid fuel having the target fuel concentration; and
a fuel cell for generating electricity by being supplied with the target concentration liquid fuel from the mixer and an oxidant gas.

2. A fuel cell system comprising:
a first cartridge in which a first liquid fuel having a first fuel concentration higher than a target fuel concentration is sealed;
a second cartridge in which a second liquid fuel having a second fuel concentration equal to or less than the target fuel concentration is sealed;
a mixer for mixing the first liquid fuel from the first cartridge with the second liquid fuel from the second cartridge to prepare a target concentration liquid fuel having the target fuel concentration; and
a fuel cell for generating electricity by being supplied with the target concentration liquid fuel from the mixer and an oxidant gas.

3. The fuel cell system according to claim 2, wherein said second fuel concentration is equal to the target fuel concentration.

4. The fuel cell system according to claim 1, further comprising a discharge liquid fuel line for allowing a discharged liquid fuel discharged from an anode of the fuel cell to return to the mixer.

5. A fuel cell system comprising:
a mixer detachably disposed and in which a target concentration liquid fuel having a target fuel concentration is sealed;
a fuel cell for generating electricity by being supplied with the target concentration liquid fuel from the mixer and an oxidant gas;
a discharge liquid fuel line for allowing a discharged liquid fuel discharged from an anode of the fuel cell to return to the mixer; and
a third cartridge in which a third liquid fuel having a third fuel concentration higher than the target fuel concentration is sealed,
wherein the fuel concentration is increased by adding the third liquid fuel from the third cartridge to the liquid fuel in the mixer whose fuel concentration is decreased.

6. The fuel cell system according to claim 5, further comprising:
a bypass line for allowing the discharged liquid fuel to bypass the mixer and to return to an upstream side of the fuel cell;
allowance means for allowing the discharged liquid fuel to flow to the bypass line; and
a buffer tank provided in the line in the bypass,
wherein, when the mixer is detached, the allowance means allows the discharged liquid fuel to flow to the bypass line, and the liquid fuel in the buffer tank is supplied to the fuel cell.

7. The fuel cell system according to claim 1, further comprising a produced water supply line for supplying the water produced at the cathode of the fuel cell to the mixer.
